(19) United States
(12) Patent Application Publication
(10) Pub. No.: US 2007/0222568 A1
(43) Pub. Date: Sep. 27, 2007

(54) System and method for vehicle tire usage information

(75) Inventors: John F. Morar, Mahopac, NY (US); Paul A. Moskowitz, Yorktown Heights, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/384,335

(22) Filed: Mar. 21, 2006

(51) Int. Cl. B60C 23/00

(52) U.S. Cl. 340/447

(57) ABSTRACT

A method (and apparatus), includes communicating, by a reader in a vehicle, with a wireless device in a tire, the wireless device having a unique identification, receiving, by the reader, sensed usage information of the tire from the wireless device, and writing, by the reader, usage parameters to a memory of the wireless device.

### BACKGROUND OF THE INVENTION

1. Field of the Invention

The present invention generally relates to a method and apparatus for gauging a characteristics of an object which undergoes wear, and more particularly to a method and apparatus for gauging a use parameter of a tire while it is mounted on a vehicle.

2. Description of the Related Art

The need to identify vehicle tires has become apparent to regulatory bodies and to manufacturers of vehicles and tires. In addition to identification, there is utility in knowing the use parameters of a given tire while it is on the vehicle and after it has been removed. Such use parameters may include mileage, maximum speed, temperature history and temperature extremes, etc. to which the tire has been subjected.

Radio transponders, known as RFID (radio frequency identification) tags may be used to identify and sense the inflation pressure of tires. One system teaches the use of RFID tags or other radio devices in vehicle tires to identify individual tires, determine inflation pressure, and the rate of rotation of a tire while the tire is mounted on the vehicle.

However, prior to the present invention, there has been no system or method which has sensed and recorded vehicle tire operating parameters in a device associated with the tire while the tire is on the vehicle.

Additionally, there has been no system or method which has retrieved information from a tire that has been used on one or more vehicles and then is separated from a vehicle.

Finally, prior to the invention, there has been no means of storing and retrieving information about a tire where the information comprises mileage of the tire, maximum speed of the tire, inflation pressure during use, and temperature extremes for the tire.

### SUMMARY OF THE INVENTION

In view of the foregoing and other exemplary problems, drawbacks, and disadvantages of the conventional methods and structures, an exemplary feature of the present invention is to provide a method and structure for sensing and recording vehicle tire operating parameters in a device associated with the tire while the tire is on the vehicle.

Another exemplary feature is to provide a system and method for retrieving information from a tire that has been used on one or more vehicles and then is separated from a vehicle.

Yet another exemplary feature of the invention is to provide means of storing and retrieving information about a tire where the information comprises mileage of the tire, maximum speed of the tire, inflation pressure during use, and temperature extremes for the tire.

In a first exemplary aspect, a method, includes communicating, by a reader in a vehicle, with a wireless device in a tire, the wireless device having a unique identification, receiving, by the reader, sensed usage information of the tire from the wireless device, and writing, by the reader, usage parameters to a memory of the wireless device.

In a second exemplary aspect, an apparatus, includes a wireless device having a unique identification embedded in a tire, a writable memory associated with the device; and tire usage information contained within the memory.

In a third exemplary aspect, an apparatus, includes a wireless device having a unique identification embedded in an object, a writable memory associated with the wireless device, and object usage information contained within the memory.

With the invention, a system and method are provided which sense and record an object's (e.g., a vehicle tire's) operating parameters in a device associated with the tire while the tire is on the vehicle.

Additionally, the system and method can retrieve information from a tire that has been used on one or more vehicles and then is separated from a vehicle.

Further, the invention provides for storage and retrieval of information about an object (e.g., a tire) where the information may include mileage of the tire, maximum speed of the tire, inflation pressure during use, and temperature extremes for the tire.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary apparatus 100 of the present invention;

FIG. 2 illustrates a computing system architecture 200 of the present invention; and

FIG. 3 is a flowchart illustrating an exemplary method 300 of the present invention.

### DETAILED DESCRIPTION OF THE INVENTION

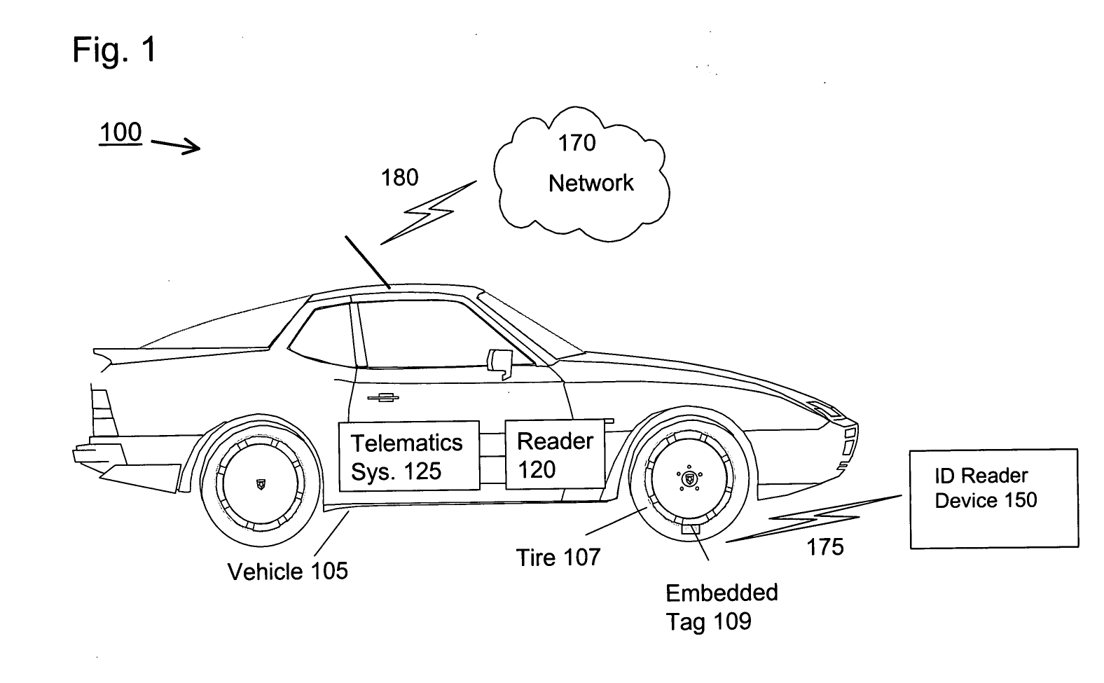

Referring now to the drawings, and more particularly to FIGS. 1-3, there are shown exemplary embodiments of the method and structures according to the present invention.

### Exemplary Embodiment

FIG. 1 shows an exemplary apparatus 100 used for an exemplary implementation of the invention.

Apparatus 100 includes a “radio” or “wireless device,” also referred to as a tag 109 embedded within an object which undergoes wear (e.g., a vehicle tire) 107. The tag or radio device 109 may be embedded such that it cannot be removed or replaced without damaging or visibly changing the tire. The radio device may be an RFID transponder tag similar to those manufactured by Texas Instruments®, Tagsys®, Intermec®, etc.

Such RFID tags may conform to standards such as ISO 15693 for high frequency tags or the EPCglobal generation 2 protocol for ultra high-frequency tags. The radio device may be a Zigbee transceiver mode compliant with the IEEE 802.15.4 standard.

The radio device contains read/write memory storage capacity. Usage parameters may be written and locked into the memory of the radio device in such that they cannot be removed or changed. RFID tags may contain 1000 to 2000 bits of readable/writable nonvolatile semiconductor memory storage.

The radio device has a unique identification number, ID, written and locked in the memory. Additionally, the radio device may be coupled to one or more sensors. Such devices with temperature sensors are manufactured by KSW Microtec®. The sensor may be an accelerometer, such as those manufactured by SignalQuest®.

Associated with the radio device embedded in the tire is a radio transceiver or reader/writer 120 located in the vehicle 105, such as that described in U.S. Pat. No. 6,571,617. The reader 120 in the vehicle may record total tire rotations and write the total to the radio device/tag 107. Rotations may be derived from the variation of the signal strength between the reader and tire device or by the modulations of the signal of the accelerometer sensor. A vehicle telematics system 125 including a computing system associated with the reader 120 may calculate the speed of the vehicle based upon the number of rotations per second and write the maximum speed to the tire device.

The tire temperature may also be derived from the temperature sensor in the tire device and stored in the memory. The various parameters may be written to the memory of the tag 109. Such parameters may include any one or more of mileage of the tire, maximum speed of the tire, inflation pressure during use, and temperature extremes for the tire or alternatively stored in the memory of the computing device associated with the reader 120, or under the control of the telematics system 125 uploaded wirelessly 180 through a network 170 from the vehicle to another remote computing system where the parameters of tire usage are associated with the tire ID and are stored. The writing and storing process may include writing a time stamp with the usage parameters to create a usage history.

Alternatively, a strain gauge may be coupled to the radio transponder tag 109. The strain gauge attached at two of its ends to the inside of the tire may be built into and coupled to the radio transponder. The device could then sense the maximum deformation of the tire, record the maximum distortion (deformation) in concert with the tire pressure, i.e. distinguish excessive static load from under-inflation—from extreme dynamic load.

The periodicity of the sensed deformation is an alternative embodiment to using an accelerometer sensor for indicating numbers of tire rotations. It may also provide an indication of the integrity of the tire, providing a predictive means for tire failure.

Also, measurement of tire distortion could be used for measuring the level of torque that should be fed to a particular tire for traction control or breaking. Relative distortion of tires on a single axle could be used to alert operators of unequal tire inflation.

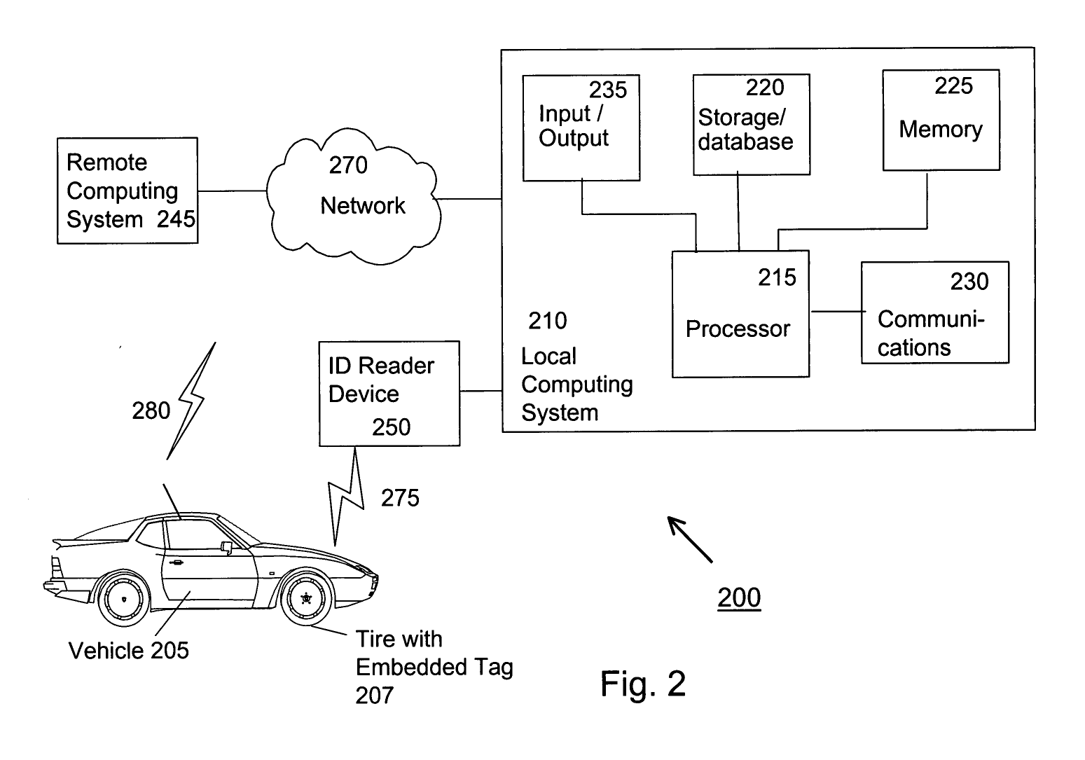

In order to retrieve the tire usage parameters while the tire is still on the vehicle or after the tire has been removed from the vehicle, another reader device 150 may be used to read the parameters directly from the tag device installed in the tire, or the ID of the tag device may be read by a reader and the parameters retrieved from the memory of the remote computing system, shown in FIG. 2.

FIG. 2 illustrates an exemplary computing system architecture 200 of the invention.

Referring to FIG. 2, the computing system architecture 200 includes a computing device or local computing system 210. The computing device may be a personal computer or server such as those manufactured by International Business Machines® (IBM®) Corporation of Armonk, N.Y. The computing device may include input/output systems 235 such as a display and keyboard, a storage device 220 such as a hard drive, computer memory 225, a processor 215, and communications capability 230 which permit the computing system to be connected to a network 270 such as the Internet and thus to other remote computing systems 245.

The computing system 210 is used to control identification, ID, reader devices 250. These ID devices may communicate with the computing system by wired or wireless means such as WiFi, 802.11x, or Bluetooth. The ID devices may include RFID readers, or other wireless reading devices.

Data on the identification and stored usage data derived from the tags embedded in tires 207 are stored in the computing system 210 along with ID information stored in the system database such as catalogs of ID numbers associated with a list of tires. All of the history of use of a specific tire may be stored in the database 220 of the computer 210 or remotely in the computer 245. The information stored in the embedded tag in the tire may be read by the reader 250 by wireless means 275 while the tire is still on the vehicle or after the tire 207 has been removed from the vehicle 205. Information, e.g., data on tire usage parameters may be uploaded wirelessly 280 through a network 270 to the remote computing system 245 where the data may be stored. Subsequent readings of the data stored in the tire tag device may, using a reader 250, be compared with the data stored in the computing system 245.

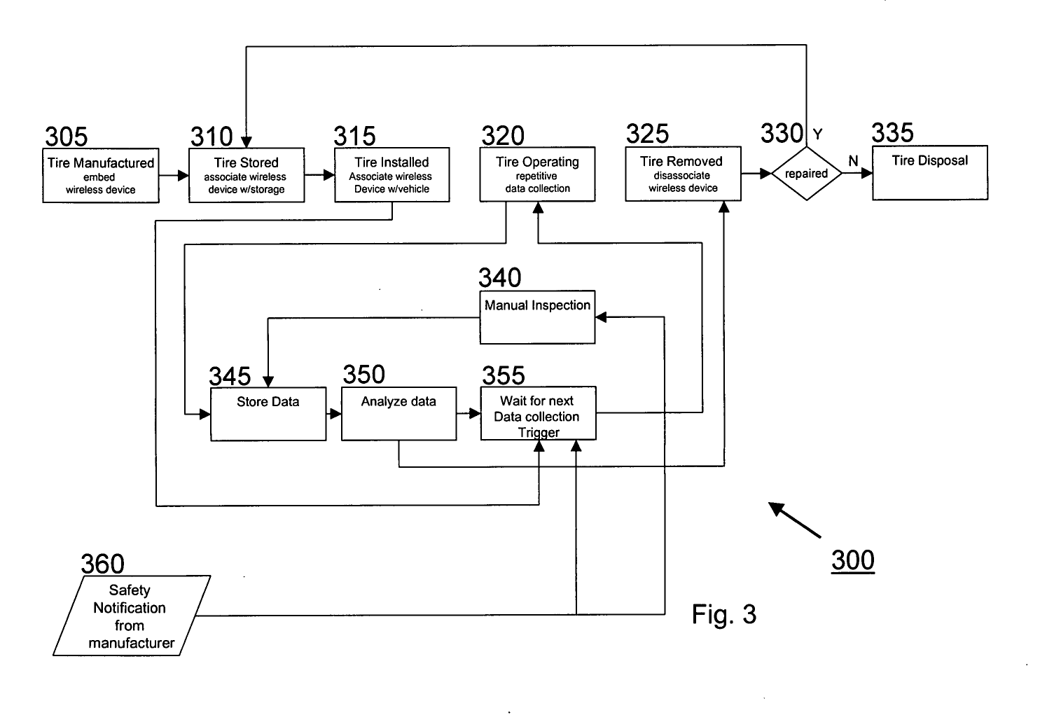

FIG. 3 illustrates a flowchart illustrating an exemplary method 300 of the invention.

This flowchart illustrates a scenario in which the invention is incorporated in an overall system for collecting and using the data that originates from the tire monitor. In this exemplary scenario, a wireless device, as described above, is embedded in the tire during the tire manufacturing process (step 305). It is embedded in the tire in a manner that makes the removal, replacement or substitution of a similar device detectable upon detailed tire inspection.

After manufacture, the tire may be stored (step 310) in a variety of locations such as warehouses, or even as a spare to be carried in a vehicle. Some system implementations may associate the specific tire ID with the tire's storage location or other storage characteristics.

At some point, the tire is removed from storage and installed on a vehicle (step 315). At this point, the individual tire ID is associated with the vehicle and tire monitoring begins. Data is collected on a periodic or continuous basis. In the scenario represented here, the data is collected on a periodic basis, based on a trigger that is emitted (step 355).

During the operational phase (step 320), data is collected whenever a trigger is emitted from step 355. Step 355 emits triggers when receiving information of installation (from step 315) or external notifications (step 360) (e.g., a safety notification for the individual tire, tire class or tires in general from the tire manufacturer such as a tire recall or inspection request). An external notification (step 360) can also trigger a manual inspection. The trigger may also be periodic in time.

Both the manual inspection step (step 340) and the tire operations step (step 320) provide their data to the data storage step (step 345) which persistently stores operational and inspection data for data analysis.

Whenever the data store for a tire changes, a data analysis process (step 350) is initiated which computes a next step based on all the available data. One possible outcome of the data analysis is to cause the initiation of tire removal from the vehicle (step 325).

Another possible outcome from the data analysis is to schedule the next inspection by telling step 355 the pertinent conditions (e.g., “in 3 days” or “after the next rainstorm”) that will trigger the next automated inspection.

In step 355, the system waits for the next trigger point—when the conditions for a trigger for collecting data for a specific tire—step 355 notifies step 320 to initiate data collection and step 320 supplies the collected data to step 345, thereby completing the cycle.

Another possible outcome of the data analysis step (350) is to initiate a tire removal step (step 325). Once the tire is removed from the vehicle, the association of the wireless device with the vehicle is removed. The tire may be repaired or otherwise certified for additional use (e.g., step 330).

If the tire is certified for additional use, then it is returned to step 310 awaiting installation. If the tire is no longer available for use, then it is disposed of in step 335, thereby ending the life cycle for the tire.

The operational data stored in step 345 is maintained for a period of time in order to resolve questions about the operational lifetime of the tire that might arise, even after the tire has been disposed of.

With the invention, a system and method are provided which sense and record an object's (e.g., a vehicle tire's) operating parameters in a device associated with the tire while the tire is on the vehicle.

Additionally, the system and method can retrieve information from a tire that has been used on one or more vehicles and then is separated from a vehicle.

Further, the invention provides for storage and retrieval of information about an object (e.g., a tire) where the information may include mileage of the tire, maximum speed of the tire, inflation pressure during use, and temperature extremes for the tire.

While the invention has been described in terms of several exemplary embodiments, those skilled in the art will recognize that the invention can be practiced with modification within the spirit and scope of the appended claims.

For example, it is noted that while a tire has been exemplarily explained above, the invention is can be applied to any object which exhibits wear or predetermined parameters or characteristics.

Further, it is noted that, Applicant's intent is to encompass equivalents of all claim elements, even if amended later during prosecution.

What is claimed is:

1. A method, comprising:
communicating, by a reader in a vehicle, with a wireless device in a tire, said wireless device having a unique identification;
receiving, by said reader, sensed usage information of said tire from said wireless device; and
writing, by said reader, usage parameters to a memory of said wireless device.

2. The method of claim 1, further comprising:
reading, by a second reader, usage parameters from the memory of said wireless device after said tire is removed from said vehicle.

3. The method of claim 1, further comprising:
communicating, by said reader, said identification and said usage parameters to a remote computing system.

4. The method of claim 3, further comprising:
retrieving said identification and said usage parameters from said remote computing system.

5. The method of claim 1, further comprising:
writing a time stamp with said usage parameters to create a usage history.

6. An apparatus, comprising:
a wireless device which is embeddable in an object;
means for communicating, in a vehicle, with said wireless device in said object, said wireless device having a unique identification;
means for receiving sensed usage information of said object from said wireless device; and
means for writing usage parameters to said wireless device.

7. The apparatus of claim 6, further comprising:
a second means for communicating for reading usage parameters from said wireless device after said object is removed from said vehicle.

8. The apparatus of claim 6, wherein said means for communicating communicates said identification and said usage parameters to a remote computing system.

9. The apparatus of claim 8, further comprising:
means for retrieving said identification and said usage parameters from said remote computing system; and
means for writing a time stamp with said usage parameters to create a usage history.

10. An apparatus, comprising:
a wireless device having a unique identification embedded in a tire;
a writable memory associated with said device; and
tire usage information contained within said memory

11. The apparatus of claim 10, wherein said usage information comprises parameters that comprise at least one of mileage of the tire, a maximum speed of the tire, an inflation pressure during use, deformation of the tire, and temperature history for the tire.

12. The apparatus of claim 10, wherein said wireless device comprises a radio transponder and an accelerometer sensor.

13. The apparatus of claim 12, wherein said wireless device further comprises one of a pressure sensor, and a temperature sensor.

14. The apparatus of claim 10, wherein said wireless device comprises a radio transponder and a strain sensor.

15. An apparatus, comprising:
a wireless device having a unique identification embedded in an object;
a writable memory associated with said wireless device; and
object usage information contained within said memory.

16. The apparatus of claim 15, wherein said object comprises a tire.

17. The apparatus of claim 16, wherein said usage information comprises parameters that comprise at least one of mileage of the tire, a maximum speed of the tire, an inflation pressure during use, deformation of the tire, and temperature history for the tire.

18. The apparatus of claim 15, wherein said wireless device comprises a radio transponder and an accelerometer sensor.

19. The apparatus of claim 18, wherein said wireless device further comprises one of a pressure sensor, and a temperature sensor.

20. The apparatus of claim 15, wherein said wireless device comprises a radio transponder and a strain sensor.
